(19) United States
(12) Patent Application Publication
(10) Pub. No.: US 2020/0373975 A1
(43) Pub. Date: Nov. 26, 2020

(54) METHOD AND DEVICE FOR PERFORMING TRANSMISSIONS OF DATA

(71) Applicant: MITSUBISHI ELECTRIC CORPORATION, Tokyo (JP)

(72) Inventors: Qianrui LI, Rennes Cedex 7 (FR); Nicolas GRESSET, Rennes Cedex 7 (FR); David GESBERT, Rennes Cedex 7 (FR)

(73) Assignee: MITSUBISHI ELECTRIC CORPORATION, Tokyo (JP)

(21) Appl. No.: 16/326,639

(22) PCT Filed: Sep. 28, 2017
(86) PCT No.: PCT/JP2017/036204

§ 371 Date: Feb. 19, 2019

(30) Foreign Application Priority Data
Oct. 7, 2016 (EP) 16192879.1

(51) Int. Cl. H04B 7/0456; H04B 7/024

(52) U.S. Cl. CPC H04B 7/0456; H04B 7/024

(57) ABSTRACT

For determining, in a distributed fashion, precoders to be applied for performing transmissions of data between a plurality of transmitters and a plurality of receivers via a global MIMO channel H of a wireless communication system, said precoders jointly forming an overall precoder V, each and every j-th transmitter perform: gathering long-term statistics of CSIT errors incurred by each one of the transmitters; obtaining short-term CSIT related data and building therefrom its own view Ĥ^{(j)} of the global MIMO channel H; determining an estimate \tilde{V}^{(j)} of the overall precoder V from the short-term CSIT related data; refining the estimate \tilde{V}^{(j)} on the basis of the gathered long-term statistics of CSIT errors so as to obtain a refined precoder \tilde{V}^{(j)} that is a view of the overall precoder V from the standpoint of said j-th transmitter, further on the basis of its own view Ĥ^{(j)} of the global MIMO channel H, and further on the basis of a figure of merit representative of performance of said transmissions via the global MIMO channel H.

### TECHNICAL FIELD

The present invention generally relates to determining, in a distributed fashion, precoders to be applied for transmitting data between a plurality of transmitters and a plurality of receivers in a MIMO channel-based wireless communication system.

### BACKGROUND ART

Wireless communication systems may rely on cooperation in order to improve their performance with regard to their environment. According to one example, such cooperation can be found in a context of a MIMO (Multiple-Input Multiple-Output) channel-based communications network in which node devices, typically access points such as base stations or eNodeBs, cooperate in order to improve overall robustness of communications via the MIMO channel.

So as to perform such cooperation, transmitters of a considered wireless communication system rely on CSI (Channel State Information) related data and/or channel estimation related data for determining a precoder to be applied by said transmitters in order to improve performance of transmissions via the MIMO channel from said transmitters to a predefined set of receivers. Such a precoder is typically determined in a central fashion, and parameters of the determined precoder are then propagated toward said transmitters for further applying said determined precoder during transmissions via the MIMO channel from said transmitters to said receivers.

It would be advantageous, in terms of system architecture and in terms of balance of processing resources usage, to provide a method for enabling determining the precoder parameters in a distributed fashion among the transmitters. However, doing so, CSIT (CSI at Transmitter) mismatch generally appears. This may involve a significant divergence between the precoder parameters computed by the transmitters on their own. The performance enhancement targeted by the cooperation is therefore not as high as expected, since the precoder parameters independently determined by the transmitters involve residual interference that grows with the CSIT mismatch.

It is desirable to overcome the aforementioned drawbacks of the prior art. It is more particularly desirable to provide a solution that allows improving performance of transmissions from a predefined set of transmitters toward a predefined set of receivers in a MIMO-channel based wireless communication system by relying on a precoder determined in a distributed fashion among said transmitters, although CSIT mismatch may exist.

### SUMMARY OF INVENTION

To that end, the present invention concerns a method for performing transmissions of data between a plurality of Kₜ transmitters and a plurality of Kᵣ receivers via a global MIMO channel H=[H₁, . . . ,H_{K}_{ᵣ}] of a wireless communication system, by determining in a distributed fashion precoders to be applied for performing said transmissions, said precoders being respectively applied by said transmitters and jointly forming an overall precoder V, wherein each and every j-th transmitter among said plurality of Kₜ transmitters performs: gathering long-term statistics of Channel State Information at Transmitter CSIT errors incurred by each one of the Kₜ transmitters with respect to the global MIMO channel H, the long-term statistics describing the random variation of the CSIT errors; obtaining short-term CSIT related data and building its own view Ĥ^{(j)} of the global MIMO channel H; determining an estimate \tilde{V}^{(j)} of the overall precoder V from the obtained short-term CSIT related data; refining the estimate \tilde{V}^{(j)}[\tilde{V}₁^{(j)}, . . . ,\tilde{V}_{K}_{ᵣ}^{(j)}] of the overall precoder Von the basis of the gathered long-term statistics of CSIT errors so as to obtain a refined precoder \tilde{V}^{(j)}[\tilde{V}₁^{(j)}, . . . ,\tilde{V}_{K}_{ᵣ}^{(j)}] is a view of the overall precoder V from the standpoint of said j-th transmitter, further on the basis of its own view Ĥ^{(j)} of the global MIMO channel H, and further on the basis of a figure of merit representative of performance of said transmissions via the global MIMO channel H; and transmitting the data by applying a precoder that is formed by a part of the refined precoder V^{(j)} which relates to said j-th transmitter among said plurality of Kₜ transmitters.

Thus, performance of transmissions via the global MIMO channel of the wireless communication system is improved by relying on a precoder determined in a distributed fashion, although CSIT mismatch may exist. Robustness against CSIT mismatch is thus achieved without needing a central unit to compute the precoder.

According to a particular feature, the figure of merit is a lower bound of a sum rate LBSR^{(j)} reached via the global MIMO channel H, from the standpoint of said j-th transmitter with respect to its own view Ĥ^{(j)} of the global MIMO channel H, as follows:

$${LBSR}^{( j )} = {\sum }_{k = 1}^{{K}_{r}} log \vert {det ( {EMSE}_{k}^{( j )} ( {F}_{1}^{( j )} , … , {F}_{{K}_{r}}^{( j )} ) )}^{- 1} \vert$$

$$wherein$$

$${EMSE}_{k}^{( j )} ( {F}_{1}^{( j )} , … , {F}_{{K}_{r}}^{( j )} ) = {𝔼}_{\{ {Δ}^{( 1 )} , {Δ}^{( 2 )} , … , {Δ}^{( {K}_{t} )} \vert {\hat{H}}^{( j )} \}} [ {MSE}_{k}^{( j )} ( {F}_{1}^{( j )} , … , {F}_{{K}_{r}}^{( j )} ) ]$$

wherein [symbol] represents the mathematical expectation and, wherein MSEₖ^{(j)} (F₁^{j}, . . . ,F_{K}_{ᵣ}^{(j)}) represents mean square error matrix between the data to be transmitted and a corresponding filtered received vector for a realization of estimate errors Δ⁽¹⁾, Δ⁽²⁾, . . . , Δ^{(K}^{ₜ}⁾ which matches the long terms statistics of CSIT errors.

Thus, the sum of the rate of the receivers served by said transmissions is improved by the determined precoder.

According to a particular feature, the figure of merit is the sum of traces MINMSE^{(j)}, for k=1 to Kᵣ, of EMSEₖ^{(j)} (F₁^{j}, . . . ,F_{K}_{ᵣ}^{(j)}) as follows:

$${MINMSE}^{( j )} = {\sum }_{k = 1}^{{K}_{r}} Trace ( {EMSE}_{k}^{( j )} ( {F}_{1}^{( j )} , … , {F}_{{K}_{r}}^{( j )} ) )$$

$$wherein$$

$${EMSE}_{k}^{( j )} ( {F}_{1}^{( j )} , … , {F}_{{K}_{r}}^{( j )} ) = {𝔼}_{\{ {Δ}^{( 1 )} , {Δ}^{( 2 )} , … , {Δ}^{( {K}_{t} )} \vert {\hat{H}}^{( j )} \}} [ {MSE}_{k}^{( j )} ( {F}_{1}^{( j )} , … , {F}_{{K}_{r}}^{( j )} ) ]$$

wherein E represents the mathematical expectation and, wherein MSEₖ^{(j)} (F₁^{j}, . . . ,F_{K}_{ᵣ}^{(j)}) represents the mean square error matrix between the data to be transmitted and a corresponding filtered received vector for a realization of estimate errors Δ⁽¹⁾, Δ⁽²⁾, . . . , Δ^{(K}^{ₜ}⁾ which matches the long terms statistics of CSIT errors.

Thus, the average mean square error, as perceived by the receivers is improved by the determined precoder.

According to a particular feature, refining the estimate \tilde{V}^{(j)} of the overall precoder V is performed thanks to a refinement function f(. , .), as well as a set {Fₖ^{(j)}} of refinement matrices Fₖ^{(j)}, k=1 to Kᵣ, in a multiplicative refinement strategy, as follows:

Vₖ^{(j)}=f(\tilde{V}ₖ^{(j)},\tilde{F}ₖ^{(j)})=\tilde{V}ₖ^{(j)},\tilde{F}ₖ^{(j)}

Thus, such a multiplicative refinement allows for correcting CSIT mismatch, especially in the context of block diagonalization precoding.

According to a particular feature, the overall precoder V is a block-diagonalization precoder, the transmitters have cumulatively at least as many antennas as the receivers, and refining the estimate \tilde{V}^{(j)} of the overall precoder V thus consists in optimizing the set {Fₖ^{(j)}} of the refinement matrices Fₖ^{(j)} with respect to the set {\tilde{V}ₖ^{(j)}} of the matrices \tilde{V}ₖ^{(j)}, which is obtained by applying a Singular Value Decomposition operation as follows:

Ĥ_{[k]}^{(j)}=U_{[k]}^{(j)}[D_{[k]}^{(j)}, 0][\tilde{V}′_{[k]}^{(j)},\tilde{V}″ₖ^{(j)}]†

wherein Ĥ_{[k]}^{(j)} represents a view of an aggregated interference channel estimation Ĥ_{[k]}^{(j)} for the k-th receiver among the Kᵣ receivers from the standpoint of said j-th transmitter, with

H_{[k]}=[H†₁, . . . ,H†ₖ₋₁,H†ₖ₊₁, . . . ,H†_{K}_{ᵣ}]†

wherein \tilde{V}ₖ^{(j)} is obtained by selecting, according to a predefined selection rule similarly applied by any and all transmitters, a predetermined set of N columns of the matrix \tilde{V}″ₖ^{(j)} resulting from the Singular Value Decomposition operation, wherein each receiver has a quantity N of receive antennas.

Thus, a distributed block diagonal precoder is made robust to CSIT mismatch.

According to a particular feature, the overall precoder V is an interference aware coordinated beamforming precoder with block-diagonal shape, Kₜ=Kᵣ, and each transmitter has as a quantity M of transmit antennas equal to a quantity N of receive antennas of each receiver, each transmitter communicates only with a single receiver among the Kᵣ receivers such that k=j,

wherein a sub-matrix W′ₖ such that:

Vₖ=EₖW′ₖ

is computed as the eigenvector beamforming of the channel matrix defined by Eₖ^{T}Ĥ^{(k)}Eₖ, from a Singular Value Decomposition operation applied onto, said channel matrix defined by Eₖ^{T}Ĥ^{(k)}Eₖ as follows:

Eₖ^{T}Ĥ^{(k)}Eₖ=U′ₖD′ₖW′ₖ

wherein Eₖ is defined as follows:

Eₖ=[0_{M×(k-1)M},I_{M×M},0_{M×(K}_{ₜ}_{-k)M}]^{T}

with 0_{M×(k-1)M} an M×(k−1)M sub-matrix containing only zeros, 0_{M×(K}_{ₜ}_{-k)M} an M×(Kₜ−1)M sub-matrix containing only zeros, and I_{M×M} an M×M identity sub-matrix.

Thus, a distributed coordinated beamforming precoder is made robust to CSIT mismatch.

According to a particular feature, refining the estimate \tilde{V}^{(j)} of the overall precoder V is performed thanks to a refinement function f(. , .), as well as a set {Fₖ^{(j)}} of refinement matrices Fₖ^{(j)}, k=1 to Kᵣ, in an additive refinement strategy, as follows:

Vₖ^{(j)}=f(\tilde{V}^{(j)},Fₖ^{(j)})=\tilde{V}^{(j)}+Fₖ^{(j)}

Thus, an additive refinement allows for correcting CSIT mismatch, especially in the context of regularized zeros forcing precoders.

According to a particular feature, the overall precoder V is a regularized zero-forcing precoder, and the estimate \tilde{V}^{(j)} of the overall precoder V can be expressed as follows:

\tilde{V}^{(j)}=(Ĥ^{(j)}†Ĥ^{(j)}+α^{(j)}l)⁻¹Ĥₖ^{(j)}†

wherein α^{(j)} is a scalar representing a regularization coefficient that is optimized according to statistics of the own view Ĥ^{(j)} of the global MIMO channel H from the standpoint of said j-th transmitter, and wherein α^{(j)} is shared by said j-th transmitter with the other transmitters among the Kₜ transmitters.

Thus, a Regularized Zero Forcing precoder is made robust to CSIT mismatch.

According to a particular feature, refining the estimate \tilde{V}^{(j)} of the overall precoder V is performed under the following power constraint:

Trace((f(\tilde{V}^{(j)},Fₖ^{(j)}))†f(\tilde{V}^{(j)},Fₖ^{(j)}))=N

wherein each receiver has a quantity N of receive antennas.

Thus, transmission power is restrained.

The present invention also concerns a device for performing transmissions of data between a plurality of Kₜ transmitters and a plurality of Kᵣ receivers via a global MIMO channel H=[H₁, . . . ,H_{K}] of a wireless communication system, by determining in a distributed fashion precoders to be applied for performing said transmissions, said precoders being respectively applied by said transmitters and jointly forming an overall precoder V, wherein said device is each and every j-th transmitter among said plurality of Kₜ transmitters and comprises: means for gathering long-term statistics of Channel State Information at Transmitter CSIT errors incurred by each one of the k transmitters with respect to the global MIMO channel H, the long-tem statistics describing the random variation of the CSIT errors; means for obtaining short-term CSIT related data and building its own view Ĥ^{(j)} of the global MIMO channel H; means for determining an estimate \tilde{V}^{(j)} of the overall precoder V from the obtained short-term CSIT related data; means for refining the estimate \tilde{V}^{(j)}=[\tilde{V}₁^{(j)}, . . . ,\tilde{V}_{K}_{ᵣ}^{(j)}] of the overall precoder Von the basis of the gathered long-term statistics of CSIT errors so as to obtain a refined precoder V^{(j)}=[V₁^{(j)}, . . . ,V_{K}_{ᵣ}^{(j)}] that is a view of the overall precoder V from the standpoint of said j-th transmitter, further on the basis of its own view Ĥ^{(j)} of the global MIMO channel H, and further on the basis of a figure of merit representative of performance of said transmissions via the global MEMO channel H; and means for transmitting the data by applying a precoder that is formed by a part of the refined precoder V^{(j)} which relates to said j-th transmitter among said plurality of Kₜ transmitters.

The present invention also concerns a computer program that can be downloaded from a communications network and/or stored on a medium that can be read by a computer or processing device. This computer program comprises instructions for causing implementation of the aforementioned method, when said program is run by a processor. The present invention also concerns an information storage medium, storing a computer program comprising a set of instructions causing implementation of the aforementioned method, when the stored information is read from said information storage medium and run by a processor.

Since the features and advantages related to the communications system and to the computer program are identical to those already mentioned with regard to the corresponding aforementioned method, they are not repeated here.

The characteristics of the invention will emerge more clearly from a reading of the following description of an example of embodiment, said description being produced with reference to the accompanying drawings, among which:

### BRIEF DESCRIPTION OF THE DRAWINGS

FIG. 1 schematically represents a wireless communication system in which the present invention may be implemented.

FIG. 2 schematically represents an example of hardware architecture of a communication device, as used in the wireless communication system.

FIG. 3 schematically represents an algorithm for determining, in a distributed fashion, precoders to be applied for transmitting data from a plurality of transmitters toward a plurality of receivers in the wireless communication system.

FIG. 4 schematically represents an iterative algorithm for determining refinement matrices used to refine the precoders.

### DESCRIPTION OF EMBODIMENTS

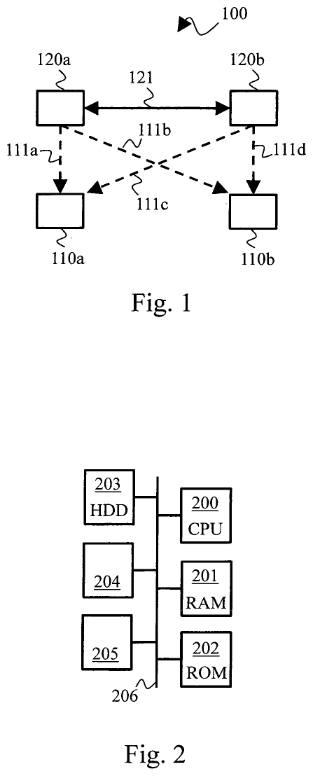

FIG. 1 schematically represents a wireless communication system 100 in which the present invention may be implemented.

The wireless communication system 100 comprises a plurality of transmitters, two 120a, 120b of which being represented in FIG. 1. The wireless communication system 100 further comprises a plurality of receivers, two 110a, 110b of which being represented in FIG. 1. For instance, the transmitters 120a, 120b are access points or base stations of a wireless telecommunications network, and the receivers 110a, 110b are mobile terminals having access to the wireless telecommunications network via said access points or base stations.

The transmitters 120a, 120b cooperate with each other in order to improve performance when performing transmissions from the plurality of transmitters 120a, 120b toward the plurality of receivers 110a, 110b via wireless links 111a, 111b, 111c, 111d. The wireless link 111a represents the transmission channel from the transmitter 120a to the receiver 110a, the wireless link 111b represents the transmission channel from the transmitter 120a to the receiver 110b, the wireless link 111c represents the transmission channel from the transmitter 120b to the receiver 110a, and the wireless link 111d represents the transmission channel from the transmitter 120b to the receiver 110b. The transmitters 120a, 120b are interconnected, as shown by a link 121 in FIG. 1A, so as to be able to exchange long-term statistics about transmission channel observations. The link 121 can be wired or wireless.

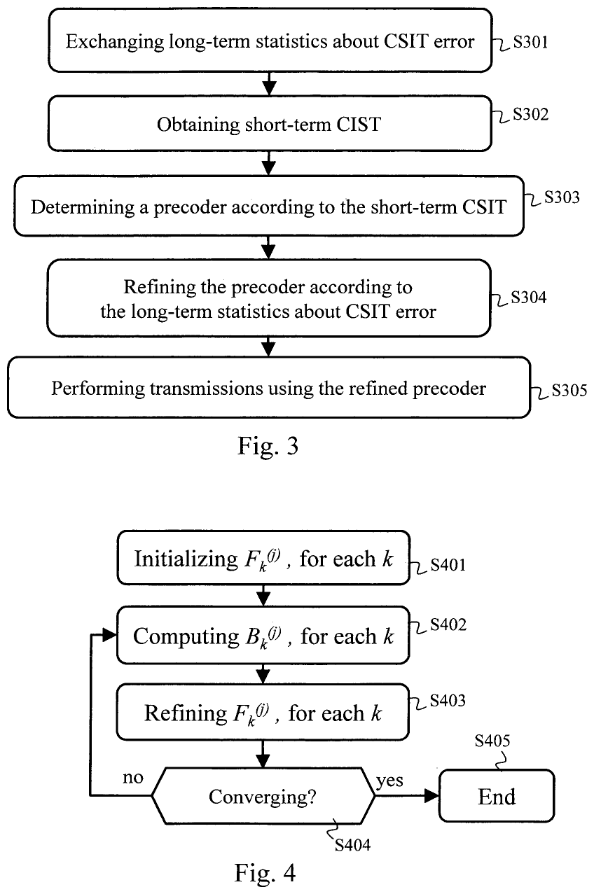

The cooperation is achieved by making the transmitters 120a, 120b apply respective precoders when performing said transmissions. Said precoders are determined in a distributed fashion within the wireless communication system so that each transmitter determines the precoder that said transmitter has to apply in the scope of said transmissions. More particularly, each transmitter (identified by an index j among the plurality of transmitters) determines, independently from the other transmitters of said plurality, its own view V^{(j)} of an overall precoder V that should be cooperatively applied by said plurality of transmitters for performing said transmissions. This aspect is detailed hereafter with respect to FIG. 3.

Herein the quantity of transmitters 120a, 120b in use is denoted Kₜ, each transmitter having a quantity M of transmit antennas, and the quantity of receivers 110a, 110b in use is denoted Kᵣ, each receiver having a quantity N of receive antennas. The receivers 110a, 110b are configured to simultaneously receive signals from plural transmitters among the Kₜ transmitters. A global MIMO channel H is thus created between the Kₜ transmitters and the Kᵣ receivers. The part of the global MIMO channel H which links a j-th transmitter among the Kₜ transmitters to a k-th receiver among the Kᵣ receivers is represented by an N×M matrix herein denoted H_{k,j}. One can note that H_{k,j} is representative a MIMO channel too. The part of the global MIMO channel H that links the k transmitters to the k-th receiver among the Kᵣ receivers is a concatenation of the Kₜ MIMO channels H_{k,j}, with j=1 to Kₜ, and is therefore an N×MKₜ matrix herein denoted Hₖ. One can further note that Hₖ is representative of a MIMO channel too.

Let's consider a set of symbol vectors sₖ. Each symbol vector sₖ of length N represents the data that has to be transmitted to the k-th receiver among the plurality of Kᵣ receivers, at a given instant. Let's further denote s the stacked vector s=[s₁^{T},s₁^{T}, . . . ,s_{K}_{ᵣ}^{T}]^{T} that contains all data to be transmitted by the Kₜ transmitters to the Kᵣ receivers at said given instant, wherein A^{T} represents the transpose of a vector or matrix A.

Let's further consider the following overall precoder V:

V=[V₁, . . . ,V_{K}_{ᵣ}]

and further define Eⱼ^{T}V, with j=1 to Kₜ, as the part of the overall precoder V to be applied by the j-th transmitter among the Kₜ transmitters, wherein Eⱼ is an M×NKᵣ matrix such that Eⱼ=[0_{M×(j-1)M},I_{M×M},0_{M×(K}_{ₜ}_{-j)M}]^{T}, and wherein Vₖ, with k=1 to Kᵣ, is the equivalent part of the overall precoder V which has to be applied to reach the k-th receiver among the Kᵣ receivers. Inline with the notations already defined hereinbefore, one should note that Vₖ^{(j)} represents hereinafter the view of the precoder equivalent part Vₖ from the standpoint of the j-th transmitter among the Kₜ transmitters.

It should be noted that 0_{M×(j-1)M} in the expression of Eⱼ above represents an M×(j−1)M sub-matrix of Eⱼ containing only zeros, 0_{M×(j-1)M} represents an M×(Kₜ−j)M sub-matrix of Eⱼ containing only zeros, and I_{M×M} represents an M×M identity sub-matrix (could be an M×M identity matrix in other contexts herein).

In a joint processing CoMP (Coordinated Multipoint Transmission) approach, any and all transmitters know entirely the set of the symbol vectors sₖ to be transmitted toward the Kᵣ receivers at a given instant.

In a coordinated precoding approach where Kₜ=Kᵣ, each transmitter among the Kₜ transmitters communicates with one receiver among the Kᵣ receivers. It means that the j-th transmitter among the Kₜ transmitters only has to know the symbol vector sₖ to be transmitted to the k-th receiver (with k=j) among the Kᵣ receivers with which said j-th transmitter communicates, which implies that the overall precoder V has a block-diagonal shape. In the case where each and every j-th transmitter among the Kₜ transmitters has to communicates with the k-th receiver among the Kᵣ receivers in such a way that k≠j, reordering of the Kₜ transmitters with respect to the index j and/or of the Kᵣ receivers with respect to the index k is performed so as to make the overall precoder V have a block-diagonal shape.

Considering the statements here above, a model of the wireless communication system 100 can be expressed as follows:

$${y}_{k} = {H}_{k} Vs + {n}_{k} = {H}_{k} {V}_{k} {s}_{k} + {\sum }_{𝓁 = 1 , 𝓁 \neq k}^{{K}_{r}} {H}_{k} {V}_{𝓁} {s}_{𝓁} + {n}_{k}$$

wherein:
yₖ represents a symbol vector as received by the k-th receiver among the Kᵣ receivers when the symbol vector sₖ has been transmitted to said k-th receiver; and nₖ represents an additive noise incurred by said k-th receiver during the transmission of the symbol vector sₖ.

It can be noticed that, in the formula above, the term HₖVₖsₖ represents the useful signal from the standpoint of the k-th receiver among the Kᵣ receivers and the sum of the terms Hₖ [symbol] represents interference incurred by the k-th receiver among the Kᵣ receivers during the transmission of the symbol vector sₖ.

A receive filter can be computed from the channel knowledge HₖV by the k-th receiver among the Kᵣ receivers, which may be obtained by a direct estimation if pilots precoded according to the overall precoder V are sent by the concerned transmitter(s) among the Kₜ transmitters, or by obtaining the overall precoder V by signalling from the concerned transmitter(s) among the Kₜ transmitters and further by estimating the MIMO channel Hₖ from pilots sent without precoding on this MIMO channel Hₖ.

When using a Zero-Forcing receive filter, the k-th receiver among the Kᵣ receivers uses a linear filter Tₖ defined as follows:

Tₖ=((HₖV)†HₖV)⁻¹(HₖV)†

When using an MMSE receive filter, the k-th receiver among the Kᵣ receivers uses a linear filter Tₖ defined as follows:

Tₖ=((HₖV)†HₖV1)⁻¹(HₖV)†

Then, a decision is made by said k-th receiver on the filtered received vector Tₖyₖ for estimating the symbol vector sₖ.

It has to be noted that, in the case where there is no effective receive filter (for instance when Regularized Zero Forcing is applied by the transmitters), Tₖ=1.

The Kₜ transmitters are configured to obtain CSIT (Channel State Information at the Transmitter). CSIT is obtained by each transmitter among the k transmitters from:
feedback CSI (Channel State Information) from one more receivers among the Kᵣ receivers, and/or
channel estimation performed at said transmitter and using a channel reciprocity property, and/or
from such CSI or such channel estimation provided by one or more other transmitters among the Kₜ transmitters,
in such a way that CSI related data and/or channel estimation related data propagation rules within the wireless communication system 100 lead to CSIT errors and moreover to CSIT mismatch among the Kₜ transmitters (i.e. different CSIT from the respective standpoints of the Kₜ transmitters), for example due to quantization operations.

One can note that, in addition to quantization operations, disparities in CSI related data effectively received by the Kₜ transmitters imply that differences in CSIT exist from one transmitter to another among the Kₜ transmitters, which leads to CSIT mismatch.

The global MIMO channel H can thus be expressed as follows, considering each and every j-th transmitter among the Kₜ transmitters:

H=Ĥ^{(j)}+Δ^{(j)}

wherein Ĥ^{(j)} represents a view of the global MIMO channel H from the standpoint of the j-th transmitter among the Kₜ transmitters, which is obtained by said j-th transmitter from the CSIT obtained by said j-th transmitter, and wherein Δ^{(j)} represents an estimate error between the effective global MIMO channel H and said view Ĥ^{(j)} of the global MIMO channel H from the standpoint of said j-th transmitter. In a similar manner, Ĥ_{k,i}^{(j)} denotes the view of the MIMO channel H_{k,i} from the standpoint of said j-th transmitter and Ĥ^{(j)} denotes the view of the MIMO channel Hₖ from the standpoint of said j-th transmitter.

Therefore, the view V^{(j)} of the overall precoder V might then be slightly different from one transmitter to another among the Kₜ transmitters, due to the CSIT mismatch. The j-th transmitter among the Kₜ transmitters then extracts, from the view V^{(j)} of the overall precoder V which has been determined by said j-th transmitter, the precoder Eⱼ^{T}V^{(j)} that said transmitter has to apply in the scope of said transmissions. As already mentioned, this is independently performed by each transmitter among the Kₜ transmitters (j=1 to Kₜ). Optimization is therefore adequately performed so as to improve the performance of the transmissions from the Kₜ transmitters to the Kᵣ receivers, in spite of the CSIT mismatch and despite that each j-th transmitter among the Kₜ transmitters independently determines the precoder Eⱼ^{T}V^{(j)} that said transmitter has to apply. This aspect is detailed hereafter with regard to FIG. 3.

FIG. 2 schematically represents an example of hardware architecture of a communication device, as used in the wireless communication system 100. The hardware architecture illustratively shown in FIG. 2 can represent each transmitter 120a, 120b of the wireless communication system 100 and/or each receiver 110a, 110b of the wireless communication system 100.

According to the shown architecture, the communication device comprises the following components interconnected by a communications bus 206: a processor, microprocessor, microcontroller or CPU (Central Processing Unit) 200; a RAM (Random-Access Memory) 201; a ROM (Read-Only Memory) 202; an SD (Secure Digital) card reader 203, or an HDD (Hard Disk Drive) or any other device adapted to read information stored on a storage medium; a first communication interface 204 and potentially a second communication interface 205.

When the communication device is one receiver among the Kᵣ receivers, the first communication interface 204 enables the communication device to receive data from the Kₜ transmitters via the global MIMO channel H. The second communication interface 205 is not necessary in this case. The first communication interface 204 further enables the communication device to feed back channel state information to one or more transmitter devices among the Kₜ transmitters.

When the communication device is one transmitter among the Kₜ transmitters, the first communication interface 204 enables the communication device to transmit data to the Kᵣ receivers, via the global MIMO channel H, cooperatively with the other transmitters among the Kₜ transmitters. The first communication interface 204 further enables the communication device to receive channel state information fed back by one or more receivers among the Kᵣ receivers. Moreover, the second communication interface 205 enables the communication device to exchange data with one or more other transmitters among the Kₜ transmitters.

CPU 200 is capable of executing instructions loaded into RAM 201 from ROM 202 or from an external memory, such as an SD card. After the communication device has been powered on, CPU 200 is capable of reading instructions from RAM 201 and executing these instructions. The instructions form one computer program that causes CPU 200 to perform some or all of the steps of the algorithm described herein.

Any and all steps of the algorithms described herein may be implemented in software by execution of a set of instructions or program by a programmable computing machine, such as a PC (Personal Computer), a DSP (Digital Signal Processor) or a microcontroller; or else implemented in hardware by a machine or a dedicated component, such as an FPGA (Field-Programmable Gate Array) or an ASIC (Application-Specific Integrated Circuit).

FIG. 3 schematically represents an algorithm for determining, in a distributed fashion within the wireless communication system 100, estimations of the overall precoder V to be applied for transmitting data from the plurality of transmitters 120a, 120b toward the plurality of receivers 110a, 110b. The algorithm shown in FIG. 3 is independently performed by each transmitter among the Kₜ transmitters. Let's illustratively consider that the algorithm of FIG. 3 is performed by the transmitter 120a, which is considered as the j-th transmitter among the Kₜ transmitters.

In a first step S301, the transmitter 120a gathers long-term statistics about the CSIT errors incurred by each one of the Kₜ transmitters with respect to the global MIMO channel H. The long terms statistics describe the random variation of the CSIT errors, which can for example be the variance of the CSIT errors.

By using a given statistical model of the CSIT errors, for example a centred Gaussian distribution, realizations of CSIT errors can be generated from the gathered long-term statistics for simulating the impact of said CSIT errors. Analytical derivation based on said statistical model and parameterized by said gathered long-term statistics can be performed.

For instance, each j-th transmitter among the Kₜ transmitters estimates or computes a variance matrix Σ_{k,i}^{(j)} associated with the channel estimation error between the MIMO channel estimation Ĥ_{k,i}^{(j)} and the effective MIMO channel defined as follows: each coefficient of the variance matrix Σ_{k,i}^{(j)} is the variance of the error between the corresponding coefficient of the MIMO channel matrices Ĥ_{k,i}^{(j)} and H_{k,i}. It has to be noted that in this case the channel estimation error is assumed to be independent from one channel coefficient to another. In a variant, a covariance matrix of the vectorization of the difference (on a per-coefficient basis) Ĥ_{k,i}^{(j)}−H_{k,i} between the MIMO channel matrices Ĥ_{k,i}^{(j)} and H_{k,i} is estimated or computed.

When there is no exchange of CSIT information between the transmitters, Ĥ^{(j)} represents an estimation, by the j-th transmitter among the Kₜ transmitters, of the global MIMO channel H. Said long term statistics are representative of the error on the CSIT, which can be computed according to a known behaviour divergence of the channel estimation technique in use with respect to the effective considered MIMO channel and according to the effective CSI feedback from the concerned receiver(s) to said j-th transmitter. For example, when pilot symbols are sent in downlink for allowing each k-th receiver among the Kᵣ receivers to estimate the MIMO channel Hₖ, the resulting estimation error is proportional to the signal to noise plus interference ratio via said MIMO channel Hₖ, and the corresponding coefficient of proportionality may be computed from the pilot density, such as in the document “Optimum pilot pattern for channel estimation in OFDM systems”, Ji-Woong Choi et al, in IEEE Transactions on Wireless Communications, vol. 4, no. 5, pp. 2083-2088, Sept. 2005. This allows computing statistics relative to the downlink channel estimation error. When channel reciprocity is considered, each j-th transmitter among the Kₜ transmitters can learn the CSIT from a channel estimation in uplink direction, similar technique as in downlink is used to compute the uplink channel estimation error statistics. When a feedback link is used for obtaining the CSIT at the transmitter from a CSI feedback computed from a channel estimation made by the concerned receiver(s), quantization error statistics on CSI can be estimated in the long term by the concerned receiver(s) and fed back to said j-th transmitter, or said quantization error statistics on CSI can be deduced from analytical models. Indeed, each concerned receiver knows the effective CSI as well as the quantization function, thus the effective quantization error. Said receiver is then able to compute the quantization error statistics over time and is then able to feed them back to said j-th transmitter. For example, the receiver builds an histogram of the quantization error representing the distribution of the quantization error and feeds it back to the j-th transmitter. For example, the receiver and transmitters assume that the quantization error is multivariate Gaussian distributed, and the receiver estimates the mean vector and the covariance variance which are fed back to the j-th transmitter. Any of the above techniques can be combined to obtain said CSIT error statistics associated to the estimation Ĥ^{(j)} of the global MIMO channel H from the standpoint of the j-th transmitter. Then these long-term statistics can be exchanged between the transmitters, in such a way that each j-th transmitter among the Kₜ transmitters gathers long-term statistics about the CSIT errors incurred by each one of the Kₜ transmitters with respect to the global MIMO channel H (which means that all the Kₜ transmitters share the same long-term statistics).

In another example said long-term statistics are gathered as disclosed in the document “A cooperative channel estimation approach for coordinated multipoint transmission networks”, Qianrui Li et al, IEEE International Conference on Communication Workshop (ICCW), pp. 94-99, 8-12 Jun. 2015, where a combination of channel estimates is performed between transmitter nodes in order to compute the estimation Ĥₖᵢ^{(j)} by each j-th transmitter among the Kₜ transmitters, of the MIMO channel H_{k,i}, and the combination is then optimized to minimize the mean square error associated with the difference (on a per-coefficient basis) Ĥ_{k,i}^{(j)}−H_{k,i} between the MIMO channel-matrices Ĥ_{k,i}^{(j)} and H_{k,i}. The variance^{matrices Σ}_{k,i}^{(j)} ) are thus the result of the combination method described in said document.

Thus, in a particular embodiment, the transmitter 120a gathers the variance matrices Σ_{k,i}^{(j)} which entries are the variance of the entries of the estimate error Δ_{k,i}^{(j)} between the effective MIMO channel H_{k,i} and the estimation Ĥ_{k,i}^{(j)} of the MIMO channel H_{k,i} from the standpoint of the j-th transmitter among the Kₜ transmitters.

Once the step S301 has been performed by each one of the Kₜ transmitters, all the Kₜ transmitters share the same long-term statistics about the CSIT errors. The step S301 is performed in an independent process than the process typically in charge of effectively configuring the Kₜ transmitters so as to transmit the aforementioned set of the symbols vectors sₖ.

It can be noted that since the aforementioned statistics about the CSIT errors are by definition long-term data, the latency for ensuring that each one of the Kₜ transmitters receives said long-term statistics has low importance. Quantization is typically not a limiting factor for transmitting such long-term statistics. On the contrary, the latency for propagating data used by the Kₜ transmitters so that each transmitter among the Kₜ transmitters is able to build its own CSIT is of most importance, in order for the wireless communication system 100 to have good reactivity. Quantization with few levels can then be necessary for transmitting such CIST related data and can drastically reduce the quality of the information. By the way, confusion shall be avoided between long-term statistics about CSIT errors received by the transmitter 120a in the step S301 and CSIT related data needed by the transmitter 120a to have its own view Ĥ^{(j)} of the global MIMO channel H.

In a step S302, the transmitter 120a obtains up-to-date (i.e. short-term) CSIT related data needed by the transmitter 120a to have its own view Ĥ^{(j)} of the global MIMO channel H. The transmitter 120a preferably shares the CSIT obtained in the step S302 with one or more transmitters among the Kₜ transmitters, in order to help said one or more transmitters to build their own respective view of the global MIMO channel H.

Once the step S302 is performed by all the Kₜ transmitters independently (substantially in parallel), the CSIT finally obtained by the Kₜ transmitters differs from one transmitter to another one among the Kₜ transmitters, which leads to CSIT mismatch.

In a step S303, the transmitter 120a determines an initial version \tilde{V}^{(j)}, from the standpoint of the transmitter 120a (considered as the j-th transmitter among the Kₜ transmitters), of the overall precoder V from the CSIT related data obtained by the transmitter 120a in the step S302. The initial version \tilde{V}^{(j)} of the overall precoder Vis therefore an estimate of the overall precoder V. Since there is CSIT mismatch, this initial version \tilde{V}^{(j)} of the overall precoder V may involve residual interference that grows with the CSIT mismatch.

In a particular embodiment, the type of the overall precoder V and thus of the estimate \tilde{V}^{(j)} of the overall precoder V are both of one precoder type among the followings:
block-diagonalization precoders, for coordinated multi-point transmissions with joint processing, as addressed in the document “Cooperative Multi-Cell Block Diagonalization with Per-Base-Station Power Constraints”, Rui Zhang, in IEEE Journal on Selected Areas in Communications, vol. 28, no. 9, pp. 1435-1445, December 2010;
interference aware coordinated beamforming precoders, for coordinated multi-point transmissions with coordinated precoding, as addressed in the document “Interference Aware-Coordinated Beamforming in a Multi-Cell System”, Chan-Byoung Chae et al, in IEEE Transactions on Wireless Communications, vol. 11, no. 10, pp. 3692-3703, October 2012; and
regularized zero-forcing precoders, for coordinated multi-point transmissions with joint processing, as addressed in the document “A large system analysis of cooperative multicell downlink system with imperfect CSIT”, Jun Zhang et al, in IEEE International Conference on Communications (ICC), pp. 4813-4817, 10-15 Jun. 2012.

A particular embodiment of the present invention for each one of these types of precoders is detailed hereafter.

It has to be noted that the initial version \tilde{V}^{(j)} of the overall precoder V from the CSIT related data obtained by the transmitter 120a (considered as the j-th transmitter among the Kₜ transmitters) can be determined as indicated in the documents referenced above with respect to each precoder type.

In a step S304, the transmitter 120a refines the initial version \tilde{V}^{(j)} of the overall precoder V according to the CSI error long-term statistics obtained in the step S301, so as to obtain a refined precoder V^{(j)}=[V₁^{(j)}, . . . ,V_{K}_{ᵣ}^{(j)}], which is the view of the overall precoder V from the standpoint of the transmitter 120a (considered as the j-th transmitter among the Kₜ transmitters).

In a particular embodiment, refining the initial version \tilde{V}^{(j)} of the overall precoder V is performed by the transmitter 120a thanks to a refinement function f(. , .), as well as a set {Fₖ^{(j)}} of refinement matrices Fₖ^{(j)}, k=1 to Kᵣ. More particularly, considering that \tilde{V}^{(j)}=[\tilde{V}₁^{(j)}, . . . ,\tilde{V}_{K}_{ᵣ}^{(j)}], refining the initial version 17(j) of the overall precoder V means refining the sub-matrices \tilde{V}^{(j)}, k=1 to Kᵣ, of the initial version \tilde{V}^{(j)} of the overall precoder V, wherein each sub-matrix \tilde{V}^{(j)} is the equivalent within \tilde{V}^{(j)} of the sub-matrix Vₖ^{(j)} within V^{(j)}.

Therefore, for each sub-matrix \tilde{V}ₖ^{(j)}, the refinement function f (. , .) and the refinement matrix Fₖ^{(j)} can be applied in a multiplicative refinement strategy, such as:

Vₖ^{(j)}=f(\tilde{V}^{(j)},Fₖ^{(j)})=\tilde{V}ₖ^{(j)}Fₖ^{(j)}

or in an additive refinement strategy:

Vₖ^{(j)}=f(\tilde{V}^{(j)},Fₖ^{(j)})=\tilde{V}ₖ^{(j)}Fₖ^{(j)}

preferably under the following power constraint:

Trace((f(\tilde{V}^{(j)},Fₖ^{(j)}))†f(\tilde{V}^{(j)},Fₖ^{(j)}))=N

It has to be noticed from the relationships above that the size of each refinement matrix Fₖ^{(j)} depends on whether the refinement strategy is additive or multiplicative.

Refining the initial version \tilde{V}^{(j)} of the overall precoder V is further performed as a function of the view Ĥ^{(j)} of the global MIMO channel H from the standpoint of the transmitter 120a (considered as the j-th transmitter among the Kₜ transmitters), as well as of a figure of merit representative of performance of transmissions from the transmitters to the receivers via the global MIMO channel H, so as to be able to determine optimized version of the set {Fₖ^{(j)}} of the refinement matrices Fₖ^{(j)}, k=1 to Kᵣ. In such a wireless communication system, the figure of merit that is representative of performance of the transmissions via the global MIMO channel H is typically a multi-user performance metric.

It has to be noted that the precoder V^{(j)} being a refined version of the initial version \tilde{V}^{(j)} of the overall precoder V from the standpoint of each j-th transmitter among the Kₜ transmitters computed from its own view Ĥ^{(j)} of the global MIMO channel H, a mismatch exists between the precoders V^{(j)} independently computed by all the Kₜ transmitters. Thus, a refinement operation should be designed so as to minimize the impact of the mismatch on the performance characterized by the figure of merit. It can be noted that the transmitters have two types of information for designing the precoder V^{(j)}: first, the local CSIT, which is represented by the view Ĥ^{(j)} of the global MIMO channel H from the standpoint of each j-th transmitter, and which is exploited to compute the initial version \tilde{V}^{(j)} of the overall precoder V, and the long term statistics on estimate error between the effective global MIMO channel H and said view Ĥ^{(j)}, which are shared between all transmitters and can thus be exploited for said refinement operation. Since a statistics-based refinement is considered, the refinement operation is a statistical method that computes a refined precoder V^{(j)} out of a set of intermediate random variable \tilde{V}^{(j)} characterizing the possible overall precoder V in view of the previously determined initial version \tilde{V}^{(j)} of the overall precoder V and of the long term statistics on estimate error between the effective global MIMO channel H and said view Ĥ^{(j)} for each j-th transmitter. Furthermore, the refinement strategy (multiplicative or additive) can be defined in order to be able to statistically correct the initial version \tilde{V}^{(j)} into V^{(j)}, said refinement strategy involving parameters to be optimized so as to statistically reduce the impact of the mismatch on the performance.

Thus, each j-th transmitter can compute the distribution of an intermediate random variable \tilde{V}^{(j)} (as defined hereafter), or generate realizations thereof, associated with the overall precoder V after refinement by all the transmitters, according to the refinement strategy (multiplicative or additive) in use and to the gathered long-term statistics about the CSIT errors, further according to the initial version \tilde{V}^{(j)} of the overall precoder V from the standpoint of said j-th transmitter and of it own view Ĥ^{(j)} of the global MIMO channel H, as detailed hereafter.

In a first particular embodiment, the figure of merit is a lower bound of a sum rate LBSR^{(j)} reached via the global MIMO channel H, from the standpoint of the transmitter 120a (considered as the j-th transmitter among the Kₜ transmitters), with respect to its own view Ĥ^{(j)} of the global MIMO channel H. The sum rate lower bound LBSR^{(j)} is a function of the set {Fₖ^{(j)}}. Considering that the transmitter 120a views the global MIMO channel H as being Ĥ^{(j)}, the sum rate lower bound LBSR^{(j)} is then defined as follows:

$${LBSR}^{( j )} = {\sum }_{k = 1}^{{K}_{r}} log \vert {det ( {EMSE}_{k}^{( j )} ( {F}_{1}^{( j )} , … , {F}_{{K}_{r}}^{( j )} ) )}^{- 1} \vert$$

$$wherein$$

$${EMSE}_{k}^{( j )} ( {F}_{1}^{( j )} , … , {F}_{{K}_{r}}^{( j )} ) = {𝔼}_{\{ {Δ}^{( 1 )} , {Δ}^{( 2 )} , … , {Δ}^{( {K}_{t} )} \vert {\hat{H}}^{( j )} \}} [ {MSE}_{k}^{( j )} ( {F}_{1}^{( j )} , … , {F}_{{K}_{r}}^{( j )} ) ]$$

wherein [symbol] represents the mathematical expectation and, wherein MSEₖ^{(j)}(F₁^{(j)}, . . . ,F_{K}_{ᵣ}^{(j)}) represents the mean square error matrix between the symbol vector sₖ and the corresponding filtered received vector Tₖyₖ (as already explained) for a realization of the estimate errors Δ⁽¹⁾, Δ⁽²⁾, . . . , Δ^{(K}^{ₜ}⁾ which matches the long terms statistics of CSIT error as obtained in the step S301, for example by considering a centred Gaussian distribution of the CSIT errors, and for the view Ĥ^{(j)} of the global MIMO channel H from the standpoint of the transmitter 120a. As explained in more details hereafter, computing MSEₖ^{(j)} for all and any k-th receiver among the Kᵣ receivers would allow each considered j-th transmitter among the Kₜ transmitters to perform the optimization of the considered figure of merit. However, the effective realization of the estimate errors Δ⁽¹⁾, Δ⁽²⁾, . . . , Δ^{(K}^{ₜ}⁾ is unknown. An approximation is therefore performed by relying on EMSEₖ^{(j)} instead of MSEₖ^{(j)} thanks to the use of the long-term statistics about the CSIT errors, which have been gathered in the step S301.

The receiver filter Tₖ may be a function of the overall precoder V and of the global MIMO channel H, which are unknown at the transmitters. But, each j-th transmitter can instead rely on its own view Ĥ^{(j)} of the global MIMO channel H and realizations of the estimate errors Δ⁽¹⁾, Δ⁽²⁾, . . . , Δ^{(K}^{ₜ}⁾ matching the long-term statistics gathered in the step S301, so as to obtain the intermediate random variable \tilde{V}^{(j)}) and to obtain its own view Tₖ^{(j)} of each receive filter Tₖ, k=1 to Kᵣ, as described hereafter. As a remark, the intermediate random variable \tilde{V}^{(j)} and the view Tₖ^{(j)} of the receive filter Tₖ are functions of the set tel of the refinement matrices Fₖ^{(j)}, k=1 to Kᵣ.

Since EMSEₖ^{(j)} (F₁^{(j)}, . . . ,F_{K}^{(j)}) may be computed for a fixed set of parameters F₁^{(j)}, . . ,F_{K}_{ᵣ}^{(j)}, the sum rate lower bound LBSR^{(j)} may be optimized by randomly defining several candidate sets of matrices to form the set {Fₖ^{(j)}} of the refinement matrices Fₖ^{(j)}, k=1 to Kᵣ, and keeping the candidate set that minimizes the sum rate lower bound LBSR^{(j)} from the standpoint of the transmitter 120a.

In a preferred embodiment, an optimized sum rate lower bound LBSR^{(j)} is obtained thanks to an iterative algorithm as detailed hereafter with regard to FIG. 4.

In a second particular embodiment, the figure of merit is the sum of traces, for k=1 to Kᵣ, of EMSEₖ^{(j)}(F₁^{(j)}, . . . ,F_{K}^{(j)}), as follows, which leads to a simplified expression MINMSE^{(j)} thus involving simpler implementation:

$${MINMSE}^{( j )} = {\sum }_{k = 1}^{{K}_{r}} Trace ( {EMSE}_{k}^{( j )} ( {F}_{1}^{( j )} , … , {F}_{{K}_{r}}^{( j )} ) )$$

Therefore, optimization of a figure of merit being a function of EMSEₖ^{(j)}, such as the sum rate lower bound LBSR^{(j)} or the simplified expression MINMSE^{(j)}, according to the mathematical expectation of the realization of the estimate errors Δ⁽¹⁾, Δ⁽²⁾, . . . , Δ^{(K}^{ₜ}⁾, matches the long terms statistics of CSIT error as obtained in the step S301, leads to obtaining the appropriate set {Fₖ^{(j)}} of the refinement matrices Fₖ^{(j), k=}1 to Kᵣ, and then to obtaining the refined precoder V^{(j)} from said appropriate set {Fₖ^{(j)}} of the refinement matrices Fₖ^{(j)} (by applying the relevant additive or multiplicative refinement strategy).

In a step S305, the transmitter 120a performs, cooperatively with the other transmitters of the Kₜ transmitters, the transmission of the set of the symbol vectors sₖ toward the Kᵣ receivers. To do so, the transmitter 120a applies the precoder Eⱼ^{T}V^{(j)}.

The algorithm of FIG. 3 may be applied independently by all the transmitters on a regular basis. The algorithm of FIG. 3 may be applied independently by all the transmitters upon detecting that the global MIMO channel H has changed beyond a predefined threshold. The algorithm of FIG. 3 may be applied independently by all the transmitters before each transmission of data from the Kₜ transmitters toward the Kᵣ receivers.

Particular embodiment for block-diagonalization precoders

In this particular embodiment, the overall precoder V is a block-diagonalization precoder. It is then assumed that KₜM≥KᵣN. By definition of block-diagonalization, considering the k-th receiver among the Kᵣ receivers, the interference induced by the MIMO channels for all other receivers among the Kᵣ receivers is supposed to be eliminated, which means that, ideally:

Hₖ [symbol] =0, ∀ [symbol] ≠k

Let's denote H_{[k}] an aggregated interference channel for the k-th receiver among the Kᵣ receivers, which is expressed as follows:

H_{[k}]=[H₁†, . . . ,Hₖ₋₁†,Hₖ₊₁†, . . . ,H_{K}_{ᵣ}†]†

and similarly Ĥ_{[k}] an aggregated interference channel estimation for the k-th receiver among the Kᵣ receivers, which is expressed as follows:

Ĥ_{[k}]=[Ĥ₁†, . . . ,Ĥₖ₋₁†,Ĥₖ₊₁†, . . . ,Ĥ_{K}_{ᵣ}†]†

Applying a Singular Value Decomposition (SVD) operation on the expression above of the aggregated interference channel H_{[k}] results in:

H_{[k]}=U_{[k]}[D_{[k]}, 0][V′_{[k]}, V″ₖ]†

wherein:
U_{[k}] is an N(Kᵣ−1)×N(Kᵣ−1) unitary matrix,
D _{[k}] is an N(Kᵣ−1)×N(Kᵣ−1) diagonal matrix,
V′_{[k}] is an M Kₜ×N(Kᵣ−1) matrix, and
V″ₖ is an MKₜ×MKₜ−N(Kᵣ−1) matrix.
   The size of the part Vₖ of the overall precoder V which has to be applied for transmitting data toward the k-th receiver is MKₜ×N, and Vₖ is obtained by selecting a predetermined set of N columns of the matrix V″ₖ. The predetermined set can either be, according to a predefined selection rule, the N first columns of V″ₖ or the N last columns of V″ₖ.

Considering the view H(J) of the global MIMO channel H from the standpoint of the j-th transmitter among the Kₜ transmitters, the expression above becomes:

Ĥ[k]^{(j)}U_{[k]}^{(j)}[D_{[k]}^{(j)},0][\tilde{V}′_{[k]}^{(j)},\tilde{V}″_{[k]}^{(j)}]†

wherein Ĥ_{[k]}^{(j)} represents the view of the aggregated interference channel estimation Ĥ_{[k}] for the k-th receiver among the Kᵣ receivers from the standpoint of the j-th transmitter among the Kₜ transmitters,
wherein \tilde{V}′_{[k]}^{(j)} is an MKₜ×N(Kᵣ−1) matrix equivalent to V′_{[k}] when using the estimation Ĥ^{(j)} instead of the effective global MIMO channel H and \tilde{V}″ₖ^{(j)} is an MKₜ×MKₜ−N(Kᵣ−1) matrix equivalent to V″ₖ when using the estimation Ĥ^{(j)} instead of the effective global MIMO channel H,
and wherein \tilde{V}ₖ^{(j)} is obtained by selecting a predetermined set of N columns of the matrix \tilde{V}″ₖ^{(j)} according to the predefined selection rule, the selection rule being similarly applied by any and all transmitters, and wherein \tilde{V}ₖ^{(j)} is such that the refinement function f (. , .) is used in the aforementioned multiplicative refinement strategy, which means:

Vₖ^{(j)}=\tilde{V}ₖ^{(j)}Fₖ^{(j)}

where Fₖ^{(j)} is a N×N matrix, preferably under the following constraint:

Trace(Fₖ^{(j)}Fₖ^{(j)})=N

As a result of the precoding strategy, the block-diagonalization property is conserved, which means:

Ĥₖ^{(j)}Vₗ^{(j)}=0, ∀l≠k

However, it has to be noted that the block-diagonalization property is usually not achieved during the transmission on the global MIMO channel H, since a mismatch exists between Ĥ^{(j)} and H. Thus, if the transmitters use their initial version \tilde{V}^{(j)} of the-precoder for-performing the transmissionsinterference exists between the transmissions towards the receivers. This interference can be reduced by using the statistical knowledge on the long term statistics on estimate error between the effective global MIMO channel H and said view Ĥ^{(j)}, by using the appropriate (multiplicative or additive) refinement strategy.

Therefore, by applying an SVD operation on the view Ĥ^{(j)} of the global MIMO channel H from the standpoint of the transmitter 120a (considered as the j-th transmitter among the Kₜ transmitters), the matrices \tilde{V}′[k_{]}^{(j)} and \tilde{V}ₖ^{(j)} can be determined by the transmitter 120a (considered as the j-th transmitter among the Kₜ transmitters).

Refining the initial version \tilde{V}^{(j)} of the overall precoder V thus consists in optimizing the set {Fₖ^{(j)}} of the refinement matrices Fₖ^{(j)} with respect to the set {\tilde{V}ₖ^{(j)}} of the matrices \tilde{V}ₖ^{(j)} obtained by the application of the Singular Value Decomposition on the view Ĥ^{(j)} of the global MIMO channel H from the standpoint of the transmitter 120a (considered as the j-th transmitter among the Kₜ transmitters). [0093]

First, a system performance metric is derived for a fixed realization of the estimate errors Δ⁽¹⁾, Δ⁽²⁾, . . . , Δ^{(K}^{ₜ}⁾ known by the transmitters, and then a statistical analysis on the estimate errors Δ⁽¹⁾, Δ⁽²⁾, . . . , Δ^{(K}^{ₜ}⁾, which are random variables, is applied according to their respective long term statistics gathered at the step S301.

Considering that an MMSE filter is implemented at each one of the Kᵣ receivers for filtering signals received from the Kₜ transmitters, the expression of the MMSE filter, as computed at the k-th receiver from the perspective of the j-th transmitter and for a fixed realization of the estimate errors Δ⁽¹⁾, Δ⁽²⁾, . . . , Δ^{(K}^{ₜ}⁾ is:

$${T}_{k}^{( j )} = {( {\hat{V}}_{k}^{( j )} )}^{†} {( {\hat{H}}_{k}^{( j )} + {Δ}_{k}^{( j )} )}^{†} {( {\sum }_{𝓁 = 1}^{{K}_{r}} ( {\hat{H}}_{k}^{( j )} + {Δ}_{k}^{( j )} ) {{\hat{V}}_{𝓁}^{( j )} ( {\hat{V}}_{𝓁}^{( j )} )}^{†} {( {\hat{H}}_{k}^{( j )} + {Δ}_{k}^{( j )} )}^{†} + I )}^{- 1}$$

wherein \tilde{V}ₖ^{(j)} is the part of the intermediate random variable \tilde{V}^{(j)} which concerns the k-th receiver among the Kᵣ receivers, by taking into account that the other transmitters among the Kₜ transmitters also have performed a refinement according to a fixed realization of the estimate errors Δ⁽¹⁾, Δ⁽²⁾, . . . , Δ^{(K}^{ₜ}⁾.

Therefore, each j-th transmitter among the Kₜ transmitters computes the following, for each and every [symbol] -th receiver among the Kᵣ ( [symbol] =1 to Kᵣ):

$${\hat{V}}_{𝓁}^{( j )} = [ \begin{matrix}{E}_{1}^{†} ( {V}_{𝓁}^{( j )} + {( {\hat{H}}_{[ 𝓁 ]}^{( j )} )}^{+} ( {Δ}_{[ 𝓁 ]}^{( 1 )} - {Δ}_{𝓁}^{( j )} ) {V}_{𝓁}^{( j )} ) \\ {E}_{2}^{†} ( {V}_{𝓁}^{( j )} + {( {\hat{H}}_{[ 𝓁 ]}^{( j )} )}^{+} ( {Δ}_{[ 𝓁 ]}^{( 2 )} - {Δ}_{[ 𝓁 ]}^{( j )} ) {V}_{𝓁}^{( j )} ) \\ ⋮ \\ {E}_{{K}_{t}}^{†} ( {V}_{𝓁}^{( j )} + {( {\hat{H}}_{[ 𝓁 ]}^{( j )} )}^{+} ( {Δ}_{[ 𝓁 ]}^{( {K}_{t} )} - {Δ}_{[ 𝓁 ]}^{( j )} ) {V}_{𝓁}^{( j )} )\end{matrix} ]$$

and wherein [symbol] represents the error estimation for the considered [symbol] -th receiver from the standpoint of the considered j-th transmitter, and

[symbol]

=[Δ₁^{(j)}†, . . . , [symbol] [symbol] , . . . , Δ_{K}_{ᵣ}^{(j)}†]†

and [symbol] represents the view of the MIMO channel [symbol] from the standpoint of the considered j-th transmitter, and [symbol] represents an estimation of the aggregated interference channel [symbol] for the considered [symbol] receiver from the standpoint of the considered j-th transmitter.

Indeed, it is reminded that:

H=Ĥ^{(j)}+Δ^{(j)}

which then means that, when a fixed realization of the estimate errors Δ⁽¹⁾, Δ⁽²⁾, . . . , Δ^{(K}^{ₜ}⁾ is known by the considered j-th transmitter, said j-th transmitter can compute the view Ĥ^{(j′)} of the global MIMO channel H from the standpoint of any other j′-th transmitter among the Kₜ transmitters as follows:

Ĥ^{(j′)}=Ĥ^{(j)}+Δ^{(j)}−Δ^{(j′)}

Thus computing [symbol] , [symbol] =1 to Kᵣ, as expressed above, allows then computing Tₖ^{(j)}, which then allows defining MSEₖ^{(j)} as follows:

$$\begin{matrix}{MSE}_{k}^{( j )} = {𝔼}_{{s}_{k} , {n}_{k}} [ ( {s}_{k} - {T}_{k}^{( j )} {y}_{k} ) {( {s}_{k} - {T}_{k}^{( j )} {y}_{k} )}^{†} ] \\ = ( I - {T}_{k}^{( j )} ( {\hat{H}}_{k}^{( j )} + {Δ}_{k}^{( j )} ) {\hat{V}}_{k}^{( j )} ) {( I - {T}_{k}^{( j )} ( {\hat{H}}_{k}^{( j )} + {Δ}_{k}^{( j )} ) {\hat{V}}_{k}^{( j )} )}^{†} + \\ {{T}_{k}^{( j )} ( {T}_{k}^{( j )} )}^{†} + \\ {T}_{k}^{( j )} ( {\hat{H}}_{k}^{( j )} + {Δ}_{k}^{( j )} ) {\sum }_{𝓁 \neq k} {{\hat{V}}_{𝓁}^{( j )} ( {\hat{V}}_{𝓁}^{( j )} )}^{†} {( {\hat{H}}_{k}^{( j )} + {Δ}_{k}^{( j )} )}^{†} {( {T}_{k}^{( j )} )}^{†}\end{matrix}$$

wherein I is an identity matrix.

Since the effective fixed realization of the estimate errors Δ⁽¹⁾, Δ⁽²⁾, . . . , Δ^{(K}^{ₜ}⁾ is unknown at the transmitters in practice, but since the estimate errors Δ⁽¹⁾, Δ⁽²⁾, . . . , Δ^{(K}^{ₜ}⁾ are associated with a given probability of occurrence that can be computed from the long term statistics on CSIT error gathered in the step S301, a statistical analysis can be used.

Each j-th transmitter (such as the transmitter 120a) is then able to compute EMSKₖ^{(j)}(F₁^{(j)}, . . . ,F_{K}_{ᵣ}^{(j)} by using a Monte Carlo simulation, or by using a numerical integration, on the distribution of Δ⁽¹⁾, Δ⁽²⁾, . . . , Δ^{(K}^{ₜ}⁾ in view of the long term statistics on CSIT error gathered in the step S301, further with respect to the view Ĥ^{(j)} of the global MIMO channel H from the standpoint of the transmitter 120a (considered as the j-th transmitter among the Kₜ transmitters).

Alternatively a mathematical approximation provides a closed form expression of EMSEₖ^{(j)}(F₁^{(j)}, . . . ,F_{K}_{ᵣ}^{(j)}), as follows:

$$\begin{matrix}{EMSE}_{k}^{( j )} ( {F}_{1}^{( j )} , … , {F}_{{K}_{r}}^{( j )} ) = ( I + {( {\hat{H}}_{k}^{( j )} {\tilde{V}}_{k}^{( j )} {F}_{k}^{( j )} )}^{†} \times \\ ( {\sum }_{𝓁 = 1 , 𝓁 \neq k}^{{K}_{r}} {\hat{H}}_{k}^{( j )} {\tilde{V}}_{𝓁}^{( j )} {{F}_{𝓁}^{( j )} ( {\hat{H}}_{k}^{( j )} {\tilde{V}}_{𝓁}^{( j )} {F}_{𝓁}^{( j )} )}^{†} + \\ { I + {Φ}_{k}^{( j )} )}^{- 1} \\ { {\hat{H}}_{k}^{( j )} {\tilde{V}}_{k}^{( j )} {F}_{k}^{( j )} )}^{- 1}\end{matrix}$$

$$wherein$$

$${Φ}_{k}^{( j )} = {\sum }_{𝓁 = 1}^{{K}_{r}} {\sum }_{\begin{matrix}t = 1 \\ t \neq j\end{matrix}}^{{K}_{t}} {\hat{H}}_{k}^{( j )} {E}_{t} {E}_{t}^{†} {\hat{H}}_{[ 𝓁 ]}^{( j ) +} [ {{Θ}_{[ 𝓁 ]}^{( j ) ( t )} ( {\hat{H}}_{[ 𝓁 ]}^{( j ) +} )}^{†} {E}_{t} {E}_{t}^{†} + {{Θ}_{[ 𝓁 ]}^{( j ) ( j )} ( {\hat{H}}_{[ 𝓁 ]}^{( j ) +} )}^{†} {\sum }_{\begin{matrix}{t }^{′} = 1 \\ {t }^{′} \neq j\end{matrix}}^{{K}_{t}} {E}_{{t}^{′}} {E}_{{t}^{′}}^{†} ] {\hat{H}}_{k}^{( j ) †} + mdiag ( {\sum }_{t = 1 , t \neq j}^{{K}_{t}} {Σ}_{k}^{( t )} {E}_{t} diag ( {\sum }_{i = 1}^{{K}_{r}} {E}_{t}^{†} {\hat{H}}_{[ 𝓁 ]}^{( j ) +} ( {Θ}_{[ 𝓁 ]}^{( j ) ( t )} + {Θ}_{[ 𝓁 ]}^{( j ) ( j )} ) {( {\hat{H}}_{[ 𝓁 ]}^{( j ) +} )}^{†} {E}_{t} ) ) + mdiag ( {Σ}_{k}^{( j )} diag ( {\sum }_{𝓁 = 1}^{{K}_{r}} {\tilde{V}}_{𝓁}^{( j )} {{F}_{𝓁}^{( j )} ( {\tilde{V}}_{𝓁}^{( j )} {F}_{𝓁}^{( j )} )}^{†} ) )$$

$$wherein$$

$${Θ}_{[ 𝓁 ]}^{( j ) ( t )} = mdiag ( {Σ}_{[ 𝓁 ]}^{( t )} diag ( {\tilde{V}}_{𝓁}^{( j )} {{F}_{𝓁}^{( j )} ( {\tilde{V}}_{𝓁}^{( j )} {F}_{𝓁}^{( j )} )}^{†} ) )$$

$$and$$

$${Σ}_{k}^{( j )} = [ {Σ}_{k , 1}^{( j )} , … , {Σ}_{k , {K}_{t}}^{( j )} ]$$

$$and$$

$${Σ}_{[ k ]}^{( t )} = {[ {( {Σ}_{1}^{( t )} )}^{†} , … , {( {Σ}_{k - 1}^{( t )} )}^{†} , {( {Σ}_{k + 1}^{( t )} )}^{†} , … , {( {Σ}_{{K}_{r}}^{( t )} )}^{†} ]}^{†}$$

and wherein A⁺ is the Moore-Penrose pseudo-inverse of A, mdiag (.) makes a diagonal matrix from a given vector and diag (.) retrieves the diagonal entries of a matrix and stacks them into a vector.

Therefore, optimization of a figure of merit being a function of EMSEₖ^{(j)}, such as the sum rate lower bound LBSRM or the simplified expression MINMSE^{(j)}, according to the mathematical expectation of the realization of the estimate errors Δ⁽¹⁾, Δ⁽²⁾, . . . , Δ^{(K}^{ₜ}⁾ which matches the long-term statistics of CSIT error as obtained in the step S301, leads to obtaining the appropriate set {Fₖ^{(j)}} of the refinement matrices Fₖ^{(j)}, k=1 to Kᵣ, and then to obtaining the refined precoder V^{(j)} from said appropriate set {Fₖ^{(j)}} of the refinement matrices Fₖ^{(j)} by applying the aforementioned multiplicative refinement strategy.

In a preferred embodiment, an optimized sum rate lower bound LBSRU) is obtained thanks to the iterative algorithm as detailed hereafter with regard to FIG. 4.

Particular embodiment for interference aware coordinated beamforming precoders

In this particular embodiment, it is assumed that the quantity Kₜ of transmitters is equal to the quantity Kᵣ of receivers, i.e. Kₜ=Kᵣ, and that the quantity M of transmit antennas is equal to the quantity N of receive antennas, i.e. M=N. Moreover each one of the Kₜ transmitters communicates only with a single receiver among the Kᵣ. receivers. Considering any k-th receiver among the Kᵣ receivers, the j-th transmitter among the Kₜ transmitters which communicates with said k-th receiver is such that k=j. In the mathematical expressions used hereafter in the particular embodiment for interference aware coordinated beamforming precoders, the index k (only used hereinbefore for identifying any receiver among the Kᵣ receivers) can be used instead of the index j. Interference aware coordinated beamforming precoding is a sub-case of the block-diagonalization precoding detailed above. Indeed, by considering that the overall precoder V has a block diagonal structure, with Kₜ blocks of size M, it is considered that each and every k-th transmitter among the Kₜ transmitters only knows the symbol vector sₖ (and not the other symbol vectors sₗ, l≠k, that have to be transmitted by the other transmitters among the Kₜ transmitters), which is precoded by an M×M sub-matrix W′ₖ such that:

Vₖ=EₖW′ₖ

The sub-matrices W′ₖ, for k=1 to Kᵣ, are obtained by implementing beamforming and/or interference alignment based on the view Ĥ^{(k)} of the global MIMO channel H from the standpoint of each and every k-th transmitter. For example, the sub-matrices W′ₖ are computed according to an interference alignment technique, as in the document “Downlink Interference Alignment” Changho Suh et al, IEEE Transactions on Communications, vol. 59, no. 9, pp. 2616-2626, September 2011. In another example, the sub-matrices W′ₖ are computed as the eigenvector beamforming of the channel matrix defined by Eₖ^{T}Ĥ^{(k)}Eₖ, from an SVD operation applied onto said channel matrix by the considered k-th transmitter among the Kₜ transmitters, such that:

Eₖ^{T}Ĥ^{(k)}Eₖ=U′ₖD′ₖW′ₖ

wherein:
U′ₖ is an NKᵣ×NKᵣ unitary matrix, and
D′ₖ is an NKᵣ×NKᵣ diagonal matrix.

The optimization is then very similar to the approach described above with respect to the block-diagonalization precoding.

Then, the approach described above with respect to the block-diagonalization precoding can thus be similarly applied, as follows.

First, an initial version \tilde{V}^{(j)} of the overall precoder V from the standpoint of each j-th transmitter among the Kₜ transmitters is computed from its own view Ĥ^{(j)} of the global MIMO channel H, such that the overall precoder V and the initial version \tilde{V}^{(j)} thereof have a block diagonal structure. Each block defined by Eₖ^{T}\tilde{V}^{(j)}Eₖ is related to the precoder used at the k-th transmitter from the standpoint of each j-th transmitter, only for precoding the symbols vector sₖ, and is related to the sub-matrice W′ₖ previously described and determined according to an interference alignment or an the eigenvector beamforming technique.

The intial version \tilde{V}ₖ^{(j)} is such that the refinement function f (. , .) is used in the aforementioned multiplicative refinement strategy, which means:

Vₖ^{(j)}=\tilde{V}ₖ^{(j)}Fₖ^{(j)}

where Fₖ^{(j)} is a N×N matrix, preferably under the following constraint:

Trace(Fₖ^{(j)}†Fₖ^{(j)})=N

Each j-th transmitter (such as the transmitter 120a) is then able to compute EMSEₖ^{(j)}(F₁^{(j)}, . . . ,F_{K}_{ᵣ}^{(j)})) by using a Monte Carlo simulation, or by using a numerical integration, on the distribution of Δ⁽¹⁾, Δ⁽²⁾, . . . , Δ^{(K}^{ₜ}⁾ which matches the long terms statistics of CSIT error as obtained in the step S301, further with respect to the view Ĥ^{(j)} of the global MIMO channel H from the standpoint of the transmitter 120a (considered as the j-th transmitter among the Kₜ transmitters), under the constraint that the refinement matrices Fₖ^{(j)} show block-diagonal respective shapes, by using

$${EMSE}_{k}^{( j )} ( {F}_{1}^{( j )} , … , {F}_{{K}_{r}}^{( j )} ) = {\{ {Δ}^{( 1 )} , {Δ}^{( 2 )} , … , {Δ}^{( {K}_{t} )} \vert {\hat{H}}^{( j )} \}}_{} [ {MSE}_{k}^{( j )} ( {F}_{1}^{( j )} , … , {F}_{{K}_{r}}^{( j )} ) ]$$

Alternatively a mathematical approximation provides a closed form expression of EMSEₖ^{(j)}(F₁^{(j)}, . . . ,F_{K}_{ᵣ}^{(j)}), as follows:

$$\begin{matrix}{EMSE}_{k}^{( j )} ( {F}_{1}^{( j )} , … , {F}_{{K}_{r}}^{( j )} ) = ( I + {( {\hat{H}}_{k}^{( j )} {\tilde{V}}_{k}^{( j )} {F}_{k}^{( j )} )}^{†} \times \\ ( {\sum }_{𝓁 = 1 , 𝓁 \neq k}^{{K}_{r}} {\hat{H}}_{k}^{( j )} {\tilde{V}}_{𝓁}^{( j )} {{F}_{𝓁}^{( j )} ( {\hat{H}}_{k}^{( j )} {\tilde{V}}_{𝓁}^{( j )} {F}_{𝓁}^{( j )} )}^{†} + \\ { I + {Φ}_{k}^{( j )} )}^{- 1} \\ { {\hat{H}}_{k}^{( j )} {\tilde{V}}_{k}^{( j )} {F}_{k}^{( j )} )}^{- 1}\end{matrix}$$

$$wherein$$

$${Φ}_{k}^{( j )} = {\sum }_{𝓁 = 1}^{{K}_{r}} {\sum }_{\begin{matrix}t = 1 \\ t \neq j\end{matrix}}^{{K}_{t}} {\hat{H}}_{k}^{( j )} {E}_{t} {E}_{t}^{†} {\hat{H}}_{[ 𝓁 ]}^{( j ) +} [ {{Θ}_{[ 𝓁 ]}^{( j ) ( t )} ( {\hat{H}}_{[ 𝓁 ]}^{( j ) +} )}^{†} {E}_{t} {E}_{t}^{†} + {{Θ}_{[ 𝓁 ]}^{( j ) ( j )} ( {\hat{H}}_{[ 𝓁 ]}^{( j ) +} )}^{†} {\sum }_{\begin{matrix}{t }^{′} = 1 \\ {t }^{′} \neq j\end{matrix}}^{{K}_{t}} {E}_{{t}^{′}} {E}_{{t}^{′}}^{†} ] {\hat{H}}_{k}^{( j ) †} + mdiag ( {\sum }_{t = 1 , t \neq j}^{{K}_{t}} {Σ}_{k}^{( t )} {E}_{t}^{†} diag ( {\sum }_{i = 1}^{{K}_{r}} {E}_{t}^{†} {\hat{H}}_{[ 𝓁 ]}^{( j ) +} ( {Θ}_{[ 𝓁 ]}^{( j ) ( t )} + {Θ}_{[ 𝓁 ]}^{( j ) ( j )} ) {( {\hat{H}}_{[ 𝓁 ]}^{( j ) +} )}^{†} {E}_{t} ) ) + mdiag ( {Σ}_{k}^{( j )} diag ( {\sum }_{𝓁 = 1}^{{K}_{r}} {\tilde{V}}_{𝓁}^{( j )} {{F}_{𝓁}^{( j )} ( {\tilde{V}}_{𝓁}^{( j )} {F}_{𝓁}^{( j )} )}^{†} ) )$$

$$wherein$$

$${Θ}_{[ 𝓁 ]}^{( j ) ( t )} = mdiag ( {Σ}_{[ 𝓁 ]}^{( t )} diag ( {\tilde{V}}_{𝓁}^{( j )} {{F}_{𝓁}^{( j )} ( {\tilde{V}}_{𝓁}^{( j )} {F}_{𝓁}^{( j )} )}^{†} ) )$$

$$and$$

$${Σ}_{k}^{( j )} = [ {Σ}_{k , 1}^{( j )} , … , {Σ}_{k , {K}_{t}}^{( j )} ]$$

$$and$$

$${Σ}_{[ k ]}^{( t )} = {[ {( {Σ}_{1}^{( t )} )}^{†} , … , {( {Σ}_{k - 1}^{( t )} )}^{†} , {( {Σ}_{k + 1}^{( t )} )}^{†} , … , {( {Σ}_{{K}_{r}}^{( t )} )}^{†} ]}^{†}$$

Therefore, optimization of a figure of merit being a function of EMSEₖ^{(j)}, such as the sum rate lower bound LBSRW or M/NMSEW, according to the mathematical expectation of the realization of the estimate errors Δ⁽¹⁾, Δ⁽²⁾, . . . , Δ^{(K}^{ₜ}⁾ which matches the long-term statistics of CSIT error as obtained in the step S301, leads to obtaining the appropriate set {Fₖ^{(j)}} of the refinement matrices F^{U), k=}1 to Kᵣ, and then to obtaining the refined precoder V^{(j)} from said appropriate set {Fₖ^{(j)}} of the refinement matrices F^{(j)} by applying the aforementioned multiplicative refinement strategy.

In a preferred embodiment, an optimized sum rate lower bound LBSR^{(j)} is obtained thanks to the iterative algorithm detailed hereafter with regard to FIG. 4.

Particular embodiment for regularized zero-forcing precoders

In this particular embodiment, the estimate \tilde{V}^{(j)} of the overall precoder V from the standpoint of each and every j-th transmitter among the Kₜ transmitters can be expressed as follows, with respect to each and every k-th receiver among the Kᵣ receivers:

\tilde{V}ₖ^{(j)}=(Ĥ^{(j)}†Ĥ^{(j)}+α^{(j)}1)⁻¹Ĥₖ^{(j)}†

wherein α^{(j)} is a scalar representing a regularization coefficient allowing to take into account a balance between interference and useful signal after channel inversion, and allowing optimizing the Signal-to-Interference-plus-Noise Ratio (SINR), and wherein α^{(j)} is optimized according to statistics of the view Ĥ^{(j)} of the global MIMO channel H from the standpoint of the considered j-th transmitter among the Kₜ transmitters, and wherein α^{(j)} is shared by said j-th transmitter with the other transmitters among the k transmitters, and wherein α^{(j)} is obtained for example as in the document “Regularized Zero-Forcing for Multiantenna Broadcast Channels with User Selection”, Z. Wang et al, in IEEE Wireless Communications Letters, vol. 1, no. 2, pp. 129-132, April 2012, and wherein \tilde{V}ₖ^{(j)} is such that the refinement function f (. , .) is used in the aforementioned additive refinement strategy, which means:

Vₖ^{(j)}i =\tilde{V}^{(j)}+Fₖ^{(j)}

wherein Fₖ^{(j)} is a MKₜ×N matrix.

First, a system performance metric is derived for a fixed realization of the estimate errors Δ⁽¹⁾, Δ⁽²⁾, . . . , Δ^{(K}^{ₜ}⁾ known by the transmitters, and then a statistical analysis on the estimate errors Δ⁽¹⁾, Δ⁽²⁾, . . . , Δ^{(K}^{ₜ}⁾, which are random variables, is applied according to their respective long term statistics gathered at the step S301.

\tilde{V}ₖ^{(j)} can be computed for a fixed realization of Δ⁽¹⁾, Δ⁽²⁾, . . . , Δ^{(K}^{ₜ}⁾ and with respect to the view Ĥ^{(j)} of the global MIMO channel H from the standpoint of the transmitter 120a (considered as the j-th transmitter among the Kₜ transmitters), as follows:

$$\begin{matrix}{\hat{V}}_{k}^{( j )} = [ \begin{matrix}{E}_{1}^{†} {V}_{k}^{( 1 )} \\ ⋮ \\ {E}_{{K}_{t}}^{†} {V}_{k}^{( {K}_{t} )}\end{matrix} ] \\ = [ \begin{matrix}{E}_{1}^{†} ( {\tilde{V}}_{k}^{( 1 )} + {F}_{k}^{( 1 )} ) \\ ⋮ \\ {E}_{{K}_{t}}^{†} ( {\tilde{V}}_{k}^{( {K}_{t} )} + {F}_{k}^{( {K}_{t} )} )\end{matrix} ] \\ = [ \begin{matrix}{E}_{1}^{†} ( {\tilde{V}}_{k}^{( j )} + {C}^{( j {)}^{- 1}} ( {Δ}^{( 1 )} - {Δ}^{( j )} ) - 2 {C}^{{( j )}^{- 1}} \cdot Re ( ( {Δ}^{( 1 )} - {Δ}^{( j )} {)}^{†} {\hat{H}}^{( j )} ) \cdot {\tilde{V}}_{k}^{( j )} + {F}_{k}^{( 1 )} ) \\ {E}_{{K}_{t}}^{†} ( {\tilde{V}}_{k}^{( j )} + {C}^{( j {)}^{- 1}} ( {Δ}^{( 1 )} - {Δ}^{( j )} ) - 2 {C}^{{( j )}^{- 1}} \cdot Re ( ( {Δ}^{( 1 )} - {Δ}^{( j )} {)}^{†} {\hat{H}}^{( j )} ) \cdot {\tilde{V}}_{k}^{( j )} + {F}_{k}^{( {K}_{t} )} )\end{matrix} ]\end{matrix}$$

wherein Re{X} represents the real part of the complex input X,
and wherein

C^{(j)}^{^{−1}}=(Ĥ^{(j)}†Ĥ^{(j)}+α^{(j)}1)⁻¹

which then allows defining MSEₖ^{(j)} as follows:

$${MSE}_{k}^{( j )} = \frac{1 + {\sum }_{𝓁 \neq k} {‖ {( {\hat{H}}_{k}^{( j )} + {Δ}_{k}^{( j )} )}^{†} {\hat{V}}_{𝓁}^{( j )} ‖}^{2}}{1 + {\sum }_{𝓁} {‖ {( {\hat{H}}_{k}^{( j )} + {Δ}_{k}^{( j )} )}^{†} {\hat{V}}_{𝓁}^{( j )} ‖}^{2}}$$

It is reminded that EMSEₖ^{(j)} is defined as follows:

$${EMSE}_{k}^{( j )} ( {F}_{1}^{( j )} , … , {F}_{{K}_{r}}^{( j )} ) = {\{ {Δ}^{( 1 )} , {Δ}^{( 2 )} , … , {Δ}^{( {K}_{t} )} \vert {\hat{H}}^{( j )} \}}_{} [ {MSE}_{k}^{( j )} ]$$

The transmitter 120a is then able to compute

$${EMSE}_{k}^{( j )} ( {F}_{1}^{( j )} , … , {F}_{{K}_{r}}^{( j )} )$$

by using a Monte Carlo simulation, or by using a numerical integration, on the distribution of Δ⁽¹⁾, Δ⁽²⁾, . . . , Δ^{(K}^{ₜ}⁾ which matches the long terms statistics of CSIT error as obtained in the step S301, further with respect to the view Ĥ^{(j)} of the global MIMO channel H from the standpoint of the transmitter 120a (considered as the j-th transmitter among the Kₜ transmitters).

Therefore, optimization of a figure of merit being a function of EMSEₖ^{(j)}, such as the sum rate lower bound LBSR^{(j)} or MINMSEₖ^{(j)}, according to the mathematical expectation of the realization of the estimate errors Δ⁽¹⁾, Δ⁽²⁾, . . . , Δ^{(K}^{ₜ}⁾ which matches the long terms statistics of CSIT error as obtained in the step S301, leads to obtaining the appropriate set {Fₖ^{(j)}} of the refinement matrices Fₖ^{(j), k=}1 to Kᵣ, and then to obtaining the refined precoder VU) from said appropriate {Fₖ^{(j)}} of the refinement matrices Fₖ^{(j)} by applying the aforementioned additive refinement strategy.

In a preferred embodiment, an optimized sum rate lower bound LBSR^{(j)} is obtained thanks to the iterative algorithm as detailed hereafter with regard to FIG. 4.

FIG. 4 schematically represents an iterative algorithm for determining the refinement matrices Fₖ^{(j)} from an optimization of LBSR(j) and thanks to the above descriptions on how to compute EMSEₖ^{(j)}(F₁^{(j)}, . . . ,F_{K}_{ᵣ}^{(j)}). The algorithm of FIG. 4 is performed by each and every j-th transmitter among the Kₜ transmitters. Let's illustratively consider that the algorithm of FIG. 4 is performed by the transmitter 120a, considered as the j-th transmitter among the Kₜ transmitters.

It is considered, when starting executing the algorithm of FIG. 4, that the transmitter 120a knows the matrices \tilde{V}ₖ^{(j)}, Σₖ^{(j)} and Ĥₖ^{(j)} for any and all k-th receivers among the Kᵣ receivers.

In a step S401, the transmitter 120a initializes the refinement matrices Fₖ^{(j)}, for each and every k-th receiver among the Kᵣ receivers. The initialization can be set as random under the following constraint:

Trace((f(\tilde{V}ₖ^{(j)},Fₖ^{(j)}))†f(\tilde{V}ₖ^{(j)},Fₖ^{(j)}))=N

Alternatively, the refinement matrices Fₖ^{(j)} are taken as identity N×N matrices for the block diagonal case, and MKₜ×N matrices containing only zeros for the regularized zero forcing case.

In a following step S402, the transmitter 120a computes Bₖ^{(j)}, for each and every k-th receiver among the Kᵣ receivers, such that:

Bₖ^{(j)}=EMSEₖ^{(j)}(F₁^{(j)}, . . . ,F_{K}_{ᵣ}^{(j)})

In a following step S403, the transmitter 120a adjusts the refinement matrices Fₖ^{(j)}, for each and every k-th receiver among the Kᵣ receivers, as follows:

$${F}_{1}^{( j )} , … , {F}_{{K}_{r}}^{( j )} = {arg min}_{{A}_{1} , … , {A}_{{K}_{r}}} {\sum }_{i = 1}^{{K}_{r}} Trace ( {B}_{k}^{( j )} \cdot {EMSE}_{k}^{( j )} ( {A}_{1} , … , {A}_{{K}_{r}} ) )$$

such that the following constraint is preferably met:

Trace((f(\tilde{V}ₖ^{(j)},Fₖ^{(j)}))†f(\tilde{V}ₖ^{(j)},Fₖ^{(j)}))=N

In a following step S404, the transmitter 120a checks whether convergence has been reached with respect to Fᵢ^{(j)}, . . . ,F_{K}_{ᵣ}^{(j)}, for each and every k-th receiver among the Kᵣ receivers. If such convergence has been reached, a step S405 is performed in which the algorithm of FIG. 4 ends; otherwise, the step 5402 is repeated, in which Bₖ^{(j)} is updated thanks to the values of F₁^{(j)}, . . . ,F_{K}_{ᵣ}^{(j)} obtained in the last occurrence of the step S403.

The optimization of MINMSE^{(j)} can also be done in order to determine the refinement matrices Fₖ^{(j)} thanks to the above descriptions on how to compute EMSEₖ^{(j)}(F₁^{(j)}, . . . ,F_{K}_{ᵣ}^{(j)}). This leads to a convex optimization problem.

1-12. (canceled)

13. A method for performing transmissions of data between a plurality of Kₜ transmitters and a plurality of Kᵣ receivers via a global MIMO channel H=[H₁, . . . ,H_{K}_{ᵣ}] of a wireless communication system, by determining in a distributed fashion precoders to be applied for performing said transmissions, said precoders being respectively applied by said transmitters and jointly forming an overall precoder V, wherein each and every j-th transmitter among said plurality of Kₜ transmitters performs:
obtaining short-term CSIT related data and building its own view flu) of the global MIMO channel H;
determining an estimate \tilde{V}^{(j)} of the overall precoder V from the obtained short-term CSIT related data;
wherein said j-th transmitter further performs:
gathering long-term statistics of Channel State Information at Transmitter CSIT errors incurred by each one of the Kₜ transmitters with respect to the global MIMO channel H, the long-term statistics describing the random variation of the CSIT errors;
refining the estimate \tilde{V}^{(j)}=[\tilde{V}₁^{(j)}, . . . ,\tilde{V}_{K}_{ᵣ}^{(j)}] of the overall precoder V on the basis of the gathered long-term statistics of CSIT errors so as to obtain a refined precoder \tilde{V}^{(j)}=[\tilde{V}₁^{(j)}, . . . ,\tilde{V}_{K}_{ᵣ}^{(j)}] that is a view of the overall precoder V from the standpoint of said j-th transmitter, further on the basis of its own view Ĥ^{(j)} of the global MIMO channel H, and further on the basis of a figure of merit representative of performance of said transmissions via the global MIMO channel H; and
transmitting the data by applying a precoder that is formed by a part of the refined precoder V^{(j)} which relates to said j-th transmitter among said plurality of Kₜ transmitters.

14. The method according to claim 13, wherein the figure of merit is a lower bound of a sum rate LBSR^{(j)} reached via the global MIMO channel H, from the standpoint of said j-th transmitter with respect to its own view Ĥ^{(j)} of the global MIMO channel H, as follows:
$${LBSR}^{( j )} = {\sum }_{k = 1}^{{K}_{r}} log \vert {det ( {EMSE}_{k}^{( j )} ( {F}_{1}^{( j )} , … , {F}_{{K}_{r}}^{( j )} ) )}^{- 1} \vert$$
$$wherein$$
$${EMSE}_{k}^{( j )} ( {F}_{1}^{( j )} , … , {F}_{{K}_{r}}^{( j )} ) = {𝔼}_{\{ {Δ}^{( 1 )} , {Δ}^{( 2 )} , … , {Δ}^{( {K}_{t} )} \vert {\hat{H}}^{( j )} \}} [ {MSE}_{k}^{( j )} ( {F}_{1}^{( j )} , … , {F}_{{K}_{r}}^{( j )} ) ]$$
wherein Fₖ^{(j)}, k=1 to Kᵣ are refinement matrices, and wherein [symbol] represents the mathematical expectation and, wherein MSEₖ^{(j)}(F₁^{(j)}, . . . ,F_{K}_{ᵣ}^{(j)}) represents mean square error matrix between the data to be transmitted and a corresponding filtered received vector for a realization of estimate errors Δ⁽¹⁾, Δ⁽²⁾, . . . , Δ^{(K}^{ₜ}⁾ which matches the long terms statistics of CSIT errors.

15. The method according to claim 13, wherein the figure of merit is the sum of traces M/NMSE^{(j)}, for k=1 to Kᵣ, of MESEₖ^{(j)}(F₁^{(j)}, . . . ,F_{K}_{ᵣ}^{(j)}), as follows:
$${MINMSE}^{( j )} = {\sum }_{k = 1}^{{K}_{r}} Trace ( {EMSE}_{k}^{( j )} ( {F}_{1}^{( j )} , … , {F}_{{K}_{r}}^{( j )} ) )$$
$$wherein$$
$${EMSE}_{k}^{( j )} ( {F}_{1}^{( j )} , … , {F}_{{K}_{r}}^{( j )} ) = {𝔼}_{\{ {Δ}^{( 1 )} , {Δ}^{( 2 )} , … , {Δ}^{( {K}_{t} )} \vert {\hat{H}}^{( j )} \}} [ {MSE}_{k}^{( j )} ( {F}_{1}^{( j )} , … , {F}_{{K}_{r}}^{( j )} ) ]$$
wherein Fe, k=1 to Kᵣ are refinement matrices, and wherein [symbol] represents the mathematical expectation and, wherein MSEₖ^{(j)}(F₁^{(j)}, . . . ,F_{K}_{ᵣ}^{(j)}) represents the mean square error matrix between the data to be transmitted and a corresponding filtered received vector for a realization of estimate errors Δ⁽¹⁾, Δ⁽²⁾, . . . , Δ^{(K}^{ₜ}⁾ which matches the long tenns statistics of CSIT errors.

16. The method according to claim 13, wherein refining the estimate \tilde{V}^{(j)} of the overall precoder V is performed thanks to a refinement function f (. , .), as well as a set {Fₖ^{(j)}} of refinement matrices Fₖ^{(j)}, k=1 to Kᵣ, in a multiplicative refinement strategy, as follows:
Vₖ^{(j)}=f(\tilde{V}ₖ^{(j)},Fₖ^{(j)})=\tilde{V}ₖ^{(j)}Fₖ^{(j)}

17. The method according to claim 16, wherein the overall precoder V is a block-diagonalization precoder, the transmitters have cumulatively at least as many antennas as the receivers, and in that refining the estimate \tilde{V}^{(j)} of the overall precoder V thus consists in optimizing the set {Fₖ^{(j)}} of the refinement matrices Fₖ^{(j)} with respect to the set {\tilde{V}ₖ^{(j)}} of the matrices \tilde{V}ₖ^{(j)}, which is obtained by applying a Singular Value Decomposition operation as follows:
Ĥ_{[k]}^{(j)}=U_{[k]}^{(j)}[D_{[k]}^{(j)}, 0][\tilde{V}′_{[k]}^{(j)},\tilde{V}″ₖ^{(j)}]†
wherein Ĥ_{[k]}^{(j)} represents a view of an aggregated interference channel estimation H_{[k}] for the k-th receiver among the Kᵣ receivers from the standpoint of said j-th transmitter, with
H_{[k]}=[H†₁, . . . ,H†ₖ₋₁,H†ₖ₊₁, . . . ,H†_{K}_{ᵣ}]†
wherein \tilde{V}ₖ^{(j)} is obtained by selecting, according to a predefined selection rule similarly applied by any and all transmitters, a predetermined set of N columns of the matrix \tilde{V}″ₖ^{(j)} resulting from the Singular Value Decomposition operation, wherein each receiver has a quantity N of receive antennas.

18. The method according to claim 16, wherein the overall precoder V is an interference aware coordinated beamforming precoder with block-diagonal shape, Kₜ=Kᵣ, and each transmitter has as a quantity M of transmit antennas equal to a quantity N of receive antennas of each receiver, each transmitter communicates only with a single receiver among the Kᵣ receivers such that k=j,
wherein a sub-matrix W′ₖ such that:
Vₖ=EₖW′ₖ
is computed as the eigenvector beamforming of the channel matrix defined by Eₖ^{T}_{Ĥ}^{(k)}Eₖ, from a Singular Value Decomposition operation applied onto said channel matrix defined by Eₖ^{T}Ĥ^{(k)}Eₖ as follows:
Eₖ^{T}Ĥ^{(k)}Eₖ=U′ₖD′ₖW′ₖ
wherein Eₖ is defined as follows:
Eₖ=[0_{M×(k-1)M}, I_{M×M},0_{M×(K}_{ₜ}_{-k)M}]^{T}
with 0_{M×(k-1)M} an M×(k−1)M sub-matrix containing only zeros, 0_{M×(K}_{ₜ}_{-k)M} an M×(Kₜ−1)M sub-matrix containing only zeros, and I_{M×M} an M×M identity sub-matrix.

19. The method according to claim 13, wherein refining the estimate \tilde{V}^{(j)} of the overall precoder V is performed thanks to a refinement function f(. , .), as well as a set {Fₖ^{(j)}} of refinement matrices Fₖ^{(j)}, k=1 to Kᵣ, in an additive refinement strategy, as follows:
Vₖ^{(j)}=f(\tilde{V}^{(j)},Fₖ^{(j)})=\tilde{V}^{(j)}+Fₖ^{(j)}

20. The method according to claim 19, wherein the overall precoder V is a regularized zero-forcing precoder, and the estimate \tilde{V}^{(j)} of the overall precoder V can be expressed as follows:
\tilde{V}^{(j)}=(Ĥ^{(j)}†Ĥ^{(j)}+α^{(j)}l)⁻¹Ĥₖ^{(j)}†
wherein α^{(j)} is a scalar representing a regularization coefficient that is optimized according to statistics of the own view Ĥ^{(j)} of the global MIMO channel H from the standpoint of said j-th transmitter, and wherein α^{(j)} is shared by said j-th transmitter with the other transmitters among the Kₜ transmitters.

21. The method according to claim 13, wherein refining the estimate \tilde{V}^{(j)} of the overall precoder Vis perfoinied under the following power constraint:
Trace((f(\tilde{V}^{(j)},Fₖ^{(j)}))†f(\tilde{V}^{(j)},Fₖ^{(j)}))=N
wherein f (. , .) is a refinement function and Fₖ^{(j)}, k=1 to Kᵣ are refinement matrices, and wherein each receiver has a quantity N of receive antennas.

22. A non-transitory computer readable storage medium, wherein it stores a computer program comprising program code instructions which can be loaded in a programmable device for implementing the method according to claim 13, when the program code instructions are run by the programmable device.

23. A device for performing transmissions of data between a plurality of Kₜ transmitters and a plurality of Kᵣ receivers via a global MIMO channel H=[H₁, . . . ,H_{K}_{ᵣ}] of a wireless communication system, by determining in a distributed fashion precoders to be applied for performing said transmissions, said precoders being respectively applied by said transmitters and jointly forming an overall precoder V, wherein said device is each and every j-th transmitter among said plurality of Kₜ transmitters and comprises a processor configured to:
obtain short-term CSIT related data and building its own view \tilde{H}^{(j)} of the global MIMO channel H;
determine an estimate \tilde{V}^{(j)} of the overall precoder V from the obtained short-term CSIT related data;
characterized in that said device further comprises the processor configured to:
gather long-term statistics of Channel State Information at Transmitter CSIT errors incurred by each one of the Kₜ transmitters with respect to the global MIMO channel H, the long-term statistics describing the random variation of the CSIT errors;
refine the estimate \tilde{V}^{(j)} =[\tilde{V}₁^{(j)}, . . . ,\tilde{V}_{K}_{ᵣ}^{(j)}] of the overall precoder V on the basis of the gathered long-term statistics of CSIT errors so as to obtain a refined precoder \tilde{V}^{(j)} =[\tilde{V}₁^{(j)}, . . . ,\tilde{V}_{K}_{ᵣ}^{(j)}] that is a view of the overall precoder V from the standpoint of said j-th transmitter, further on the basis of its own view Ĥ^{(j)} of the global MIMO channel H, and further on the basis of a figure of merit representative of performance of said transmissions via the global MIMO channel H; and
transmit the data by applying a precoder that is formed by a part of the refined precoder V^{(j)} which relates to said j-th transmitter among said plurality of Kₜ transmitters.
